(19) United States
(12) Patent Application Publication
(10) Pub. No.: US 2025/0070365 A1
(43) Pub. Date: Feb. 27, 2025

(54) Cell Assembly and Battery Pack and Vehicle Including the Same

(71) Applicant: LG Energy Solution, Ltd., Seoul (KR)

(72) Inventors: Jin-Yong Park, Daejeon (KR); Woo-Yong Kwon, Daejeon (KR); Seung-Joon Kim, Daejeon (KR); In-Soo Kim, Daejeon (KR); Song-Ju Shin, Daejeon (KR); Myung-Woo Lee, Daejeon (KR); Jong-Mo Kang, Daejeon (KR); Kyung-Woo Kim, Daejeon (KR); Duck-Hee Moon, Daejeon (KR); Tae-Kyeong Lee, Daejeon (KR); Se-Yun Chung, Daejeon (KR); Jong-Ha Jeong, Daejeon (KR); Ho-June Chi, Daejeon (KR); Ji-Soo Hwang, Daejeon (KR)

(73) Assignee: LG Energy Solution, Ltd., Seoul (KR)

(21) Appl. No.: 18/720,989

(22) PCT Filed: Aug. 7, 2023
(86) PCT No.: PCT/KR2023/011607

§ 371 Date: Jun. 17, 2024

(30) Foreign Application Priority Data
Aug. 31, 2022 (KR) 10-2022-0110376
May 19, 2023 (KR) 10-2023-0065245

(51) Int. Cl. H01M 50/267; H01M 10/613; H01M 10/625; H01M 10/647; H01M 10/6556; H01M 50/249; H01M 50/271

(52) U.S. Cl. CPC H01M 50/267; H01M 10/613; H01M 10/625; H01M 10/647; H01M 10/6556; H01M 50/249; H01M 50/271

(57) ABSTRACT

A cell assembly according to the present disclosure includes a cell stack including one pouch-type battery cell or two or more pouch-type battery cells stacked; and a cell cover covering two side portions of the cell stack along a widthwise direction of the cell stack and a top portion of the cell stack, wherein the cell cover is configured to adjust a width of the cell cover according to a width of the cell stack.

### TECHNICAL FIELD

The present disclosure relates to a cell assembly and a battery pack and a vehicle including the same, and more particularly, to a cell assembly having a cell cover with variably adjustable width according to the thickness or number of pouch-type battery cells that are received in the cell cover and a battery pack and a vehicle including the same.

The present application claims priority to Korean Patent Application No. 10-2022-0110376 filed on Aug. 31, 2022 and Korean Patent Application No. 10-2023-0065245 filed on May 19, 2023 in the Republic of Korea, the disclosures of which are incorporated herein by reference.

### BACKGROUND ART

With the development of mobile technology and the growing demand for mobile devices, the demand for secondary batteries as an energy source is rapidly increasing. Among secondary batteries, nickel-cadmium batteries or hydrogen-ion batteries have been used, but recently, lithium secondary batteries are being used in a wide range of applications. Compared to nickel-based secondary batteries, lithium secondary batteries have little or no memory effect, and thus have advantages that recharging can be done whenever it is convenient, the self-discharge rate is very low and the energy density is high.

Lithium secondary batteries primarily comprise lithium-based oxides and carbon materials for a positive electrode active material and a negative electrode active material, respectively. A lithium secondary battery includes an electrode assembly including a positive electrode plate and a negative electrode plate coated with the positive electrode active material and the negative electrode active material, respectively, with a separator interposed between the positive electrode plate and the negative electrode plate, and a sealed packaging or battery case accommodating the electrode assembly together with an electrolyte solution.

In general, secondary batteries may be classified into can-type secondary batteries in which the electrode assembly is included in a metal can and pouch-type secondary batteries in which the electrode assembly is included in a pouch of an aluminum laminate sheet, according to the shape of the battery case.

Pouch-type secondary batteries are light-weight and can be stacked with reduced dead spaces, so they have many advantages including high energy density per volume. However, pouch-type secondary batteries are relatively vulnerable to external impacts and low efficient in assembling.

A typical battery pack includes at least one battery module and a pack case accommodating the at least one battery module, wherein each battery module includes a plurality of pouch-type battery cells and a module case accommodating the plurality of pouch-type battery cells. An example of the battery module, the prior art document (Korean Patent Publication No. 10-2015-0044599) discloses a battery module including a cell stack including a plurality of pouch-type battery cells held and stacked using a plastic frame for stacking called a cartridge, a plate at two ends in the cell stack direction, a fastener such as a bolt and the like and a module case accommodating the cell stack. In this case, it is possible to protect the pouch-type battery cells from external impacts and prevent the pouch-type battery cells from moving, thereby ensuring electrical reliability.

However, assembling the pouch-type battery cells into a battery module and mounting each battery module in the battery pack may be unfavorable in terms of energy density. In particular, since the battery module includes not only the pouch-type battery cells but also many components such as the module case, the frame for stacking and the like, the battery pack may unnecessarily increase in weight and volume. To address this problem, recently, intensive efforts are being made in research and development of so-called cell to pack type battery pack in which the plurality of pouch-type battery cells is directly mounted in the pack case without forming the battery module.

However, in the mounting process, fixing the pouch-type battery cell having the soft pouch case to the pack case is not easy and there are damage risks. Additionally, there are concerns about durability against external impacts. As disclosed in KR Patent Publication No. 10-2023-0021607, Applicant has developed a cell cover covering a portion of a predetermined number of pouch-type battery cells. However, the number or thickness of pouch-type battery cells that can be received in the cell cover is preset. Accordingly, it is impossible to increase or decrease the number of pouch-type battery cells in the cell cover according to situations during the assembly process.

### SUMMARY

### Technical Problem

The present disclosure is directed to providing a cell assembly including a cell cover with adjustable width according to the thickness or number of pouch-type battery cells to mount the pouch-type battery cells in a pack case with stability and space efficiency. The present disclosure is further directed to providing a battery pack that is simple to assemble and has enhanced energy density by using the cell assembly.

The technical problem to be solved by the present disclosure is not limited to the above-described problems, and these and other problems will be clearly understood by those skilled in the art from the following description.

### Technical Solution

According to an aspect of the present disclosure, there is provided a cell assembly including a cell stack including one pouch-type battery cell or two or more pouch-type battery cells stacked; and a cell cover covering two side portions of the cell stack along a widthwise direction of the cell stack and a top portion of the cell stack, wherein the cell cover is configured to adjust a width of the cell cover according to a width of the cell stack.

The cell cover may be configured to cover the cell stack such that a bottom portion of the cell stack is exposed.

The cell cover may include a width adjusting upper cover portion covering an upper surface portion of the cell stack, and having a variably adjustable width; a first side cover portion extending in a downward direction from an edge at one side of the width adjusting upper cover portion and covering one side portion of the cell stack; and a second side cover portion extending in the downward direction from an edge at the other side of the width adjusting upper cover portion and covering the other side portion of the cell stack.

The width adjusting upper cover portion may include a first upper cover portion integrally formed with the first side cover portion; a second upper cover portion separated from the first upper cover portion, and integrally formed with the second side cover portion; and a joint bracket unit connected to the first upper cover portion and the second upper cover portion, and configured to support the first upper cover portion and the second upper cover portion horizontally movably at a same height.

The joint bracket unit may include a cover plate portion disposed on the first upper cover portion and the second upper cover portion; and a link portion disposed in at least one end portion of the cover plate portion along a lengthwise direction of the cover plate portion, and having a bent shape to cover an end portion of the first upper cover portion and an end portion of the second upper cover portion in an inward direction.

The link portion may include a bent portion bent in the downward direction from an end portion of the cover plate portion; and a support portion extending in a direction perpendicular to the bent portion, and configured to support the first upper cover portion and the second upper cover portion together below the first upper cover portion and the second upper cover portion.

The joint bracket unit may have a first fastening hole at a preset location, and the first upper cover portion and the second upper cover portion may include at least one second fastening hole that vertically matches the first fastening hole by a relative movement with respect to the joint bracket unit.

The joint bracket unit may include a first cover plate portion disposed on the first upper cover portion and the second upper cover portion; a second cover plate portion disposed below the first upper cover portion and the second upper cover portion; and a connection portion covering an end portion of the first upper cover portion and an end portion of the second upper cover portion together and connecting the first cover plate portion to the second cover plate portion.

The first cover plate portion may have a first long hole at a preset location, each of the first upper cover portion and the second upper cover portion may have a second long hole, and the first long hole and the second long hole may match each other at least in part by the horizontal movement of the first upper cover portion or the second upper cover portion.

The cell assembly may further include a busbar assembly having a terminal busbar electrically connected to an electrode lead of the pouch-type battery cell.

According to another aspect of the present disclosure, there is provided a battery pack including a cell assembly group including the cell assemblies stacked in a direction; and a pack case including a pack tray on which the cell assembly group is mounted, and a pack cover covering the cell assembly group.

The cell assembly group may be adhered and fixed to an upper surface of the pack tray.

The pack tray may include a cooling channel in which a cooling medium flows. The pack tray may have a fixing groove to which a lower end of the cell cover is inserted and fixed.

According to still another aspect of the present disclosure, there is provided a vehicle including the battery pack.

### Advantageous Effects

According to an aspect of the present disclosure, it may be possible to provide the cell assembly including the cell cover with adjustable width according to the thickness or number of pouch-type battery cells that are received in the cell cover.

According to another aspect of the present disclosure, it may be possible to simplify the assembly process of the battery pack and improve energy density by using the cell assembly to assemble the battery pack.

The present disclosure may have many other effects, and these effects will be described in each embodiment, or regarding effects that can be easily inferred by those skilled in the art, the corresponding description is omitted.

### BRIEF DESCRIPTION OF THE DRAWINGS

FIG. 1 is a schematic perspective view of a cell assembly according to an embodiment of the present disclosure.

FIG. 2 is a schematic exploded perspective view of the cell assembly of FIG. 1.

FIG. 3 is a perspective view showing the main components of a cell cover according to an embodiment of the present disclosure.

FIG. 4 is an assembled perspective view of the cell cover of FIG. 3.

FIG. 5 is a partial enlarged view of the cell cover of FIG. 4.

FIG. 6 is a diagram showing an example of adjusting up the width of the cell cover of FIG. 4.

FIG. 7 is a partial enlarged view of the cell cover of FIG. 6.

FIG. 8 is a diagram showing examples of width adjustment of a cell cover according to an embodiment of the present disclosure to receive pouch-type battery cells according to situations.

FIG. 9 is a perspective view showing the main components of a cell cover according to another embodiment of the present disclosure.

FIG. 10 is an assembled perspective view of the cell cover of FIG. 9.

FIG. 11 is a perspective view showing the main components of a cell cover according to still another embodiment of the present disclosure.

FIG. 12 is an assembled perspective view of the cell cover of FIG. 11.

FIG. 13 is a schematic diagram of a battery pack according to an embodiment of the present disclosure.

FIG. 14 is a partial cross-sectional view of a battery pack according to an embodiment of the present disclosure.

FIG. 15 is a schematic diagram of a vehicle including a battery pack according to an embodiment of the present disclosure.

### DETAILED DESCRIPTION

Hereinafter, exemplary embodiments of the present disclosure will be described in detail with reference to the accompanying drawings. Prior to the description, it should be understood that the terms or words used in the specification and the appended claims should not be construed as being limited to general and dictionary meanings, but rather interpreted based on the meanings and concepts corresponding to the technical aspect of the present disclosure on the basis of the principle that the inventor is allowed to define the terms appropriately for the best explanation.

Therefore, the embodiments described herein and the illustrations shown in the drawings are exemplary embodiments of the present disclosure to describe the technical aspect of the present disclosure and are not intended to be limiting, so it should be understood that a variety of other equivalents and modifications could have been made thereto at the time that the application was filed.

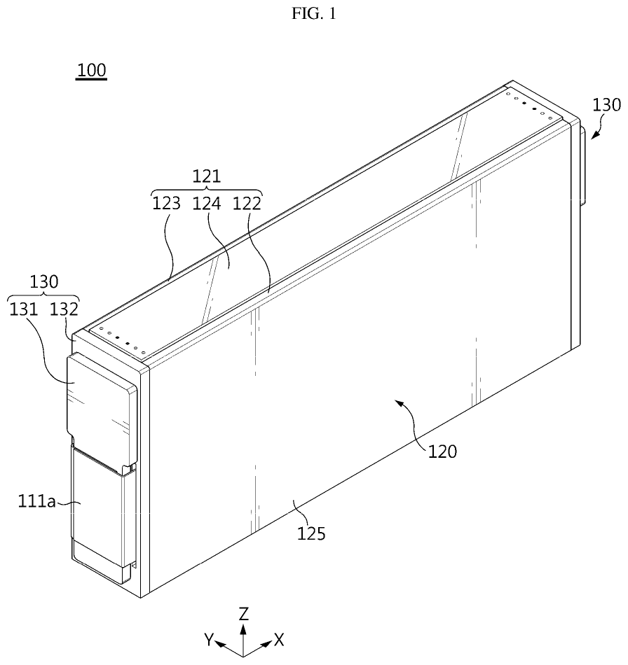

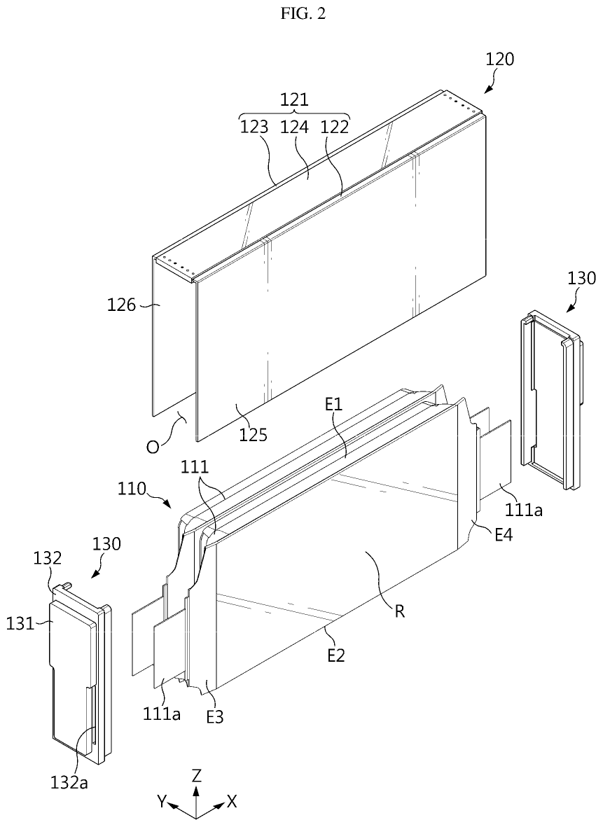

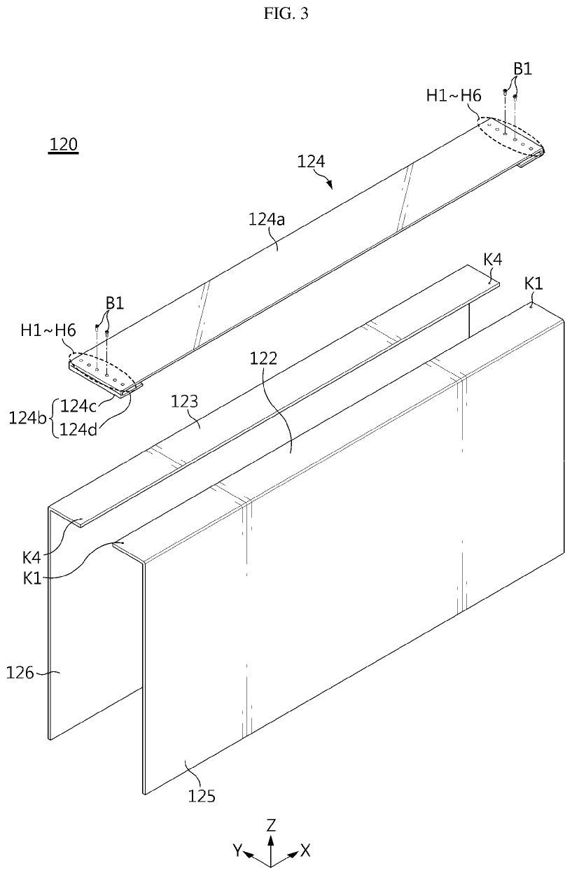

FIG. 1 is a schematic perspective view of a cell assembly according to an embodiment of the present disclosure, FIG. 2 is a schematic exploded perspective view of the cell assembly of FIG. 1, and FIG. 3 is a perspective view showing the main components of a cell cover according to an embodiment of the present disclosure.

Referring to FIGS. 1 to 3, the cell assembly 100 according to an embodiment of the present disclosure includes a cell stack 110 and the cell cover 120.

The cell stack 110 may include one pouch-type battery cell 111 or two or more pouch-type battery cells 111 stacked. The pouch-type battery cell 111 may be manufactured by receiving an electrode assembly and an electrolyte in a pouch packaging of a laminate film including a soft metal and sealing the pouch packaging. Here, the electrode assembly includes a positive electrode plate, a negative electrode plate and a separator interposed between the positive electrode plate and the negative electrode plate.

Referring to FIG. 2, the pouch-type battery cell 111 may include an electrode lead 111a that acts as an electrode lead, and the electrode lead 111a may be electrically connected to the electrode assembly and exposed to the outside of the pouch packaging. The electrode lead 111a includes a pair of a positive electrode lead and a negative electrode lead. Here, the positive electrode lead and the negative electrode lead may be disposed at front and rear end portions in the lengthwise direction (X direction) of the pouch-type battery cell 111.

Additionally, the pouch-type battery cell 111 may have a receiving portion R in which the electrode assembly is received, and four edge portions E1˜E4 disposed around the receiving portion R. The four edge portions E1˜E4 include an upper edge portion E1, a lower edge portion E2, a front edge portion E3 and a rear edge portion E4, for example, as shown in FIG. 2, on the basis of the receiving portion R in the pouch-type battery cell 111 standing upright.

Here, the edge portions E1˜E4 may be all sealing portions or three edge portions E2,E3,E4 or E1,E3,E4 except the upper edge portion E1 or the lower edge portion E2 may be sealing portions. In addition, the pouch-type battery cell 111 using a process of folding a sheet of laminate film when receiving the electrode assembly has three sealing portions, and the pouch-type battery cell 111 using a process of joining the edges of two sheets of laminate films when receiving the electrode assembly has four sealing portions. Accordingly, the three edge portions E2,E3,E4 or E1,E3,E4 or the four edge portions E1˜E4 of the pouch-type battery cell 111 may be sealing portions.

The cell cover 120 may be configured to cover at least one pouch-type battery cell 111. In other words, the cell cover 120 may be configured to cover the cell stack 110. In particular, the cell cover 120 may be configured to cover the cell stack 110 such that a bottom portion of the cell stack 110 is exposed. The cell cover 120 may be configured to cover two side portions of the cell stack 110 in the widthwise direction of the cell stack 110 and a top portion of the cell stack 110.

The cell cover 120 may be made of various types of materials to ensure stiffness. In particular, the cell cover 120 may be made of metal. When metal is used, it may be possible to keep the pouch-type battery cells 111 stacked more stably, and protect the pouch-type battery cells 111 from external impacts more safely. In particular, the cell cover 120 may be made of steel, especially, stainless steel (SUS). For example, the cell cover 120 may be fully made of SUS.

Accordingly, when the cell cover 120 covers the cell stack 110, it may be possible to stably keep the pouch-type battery cells 111 stacked and upright. In particular, the pouch-type battery cells 111 may be vulnerable to external impacts and have low hardness due to the outer packaging made of a soft material. Accordingly, it is not easy to receive the pouch-type battery cells 111 in a pack case 200. However, in the case of the present disclosure, since the pouch-type battery cells 111 are received in the cell cover 120, it may be possible to prevent damage or breakage of the pouch-type battery cells 111 from external impacts and stably keep them stacked in the pack case 200. Accordingly, there is no need to add, to a battery pack 10, a module case, a frame for stacking, a fastener for maintaining the stack and so on. As a result, it may be possible to receive a larger number of battery cells 111 in the pack case 200, thereby enhancing energy density of the battery pack 10.

Referring to FIGS. 1 and 2, the cell assembly 100 according to an embodiment of the present disclosure may further include a busbar assembly 130.

The busbar assembly 130 may include a terminal busbar 131 electrically connected to the electrode lead 111a of the pouch-type battery cell 111 received in the cell cover 120, and be coupled to a front open end portion O and a rear open end portion of the cell cover 120.

Specifically, referring to FIG. 2, the busbar assembly 130 according to this embodiment may include the terminal busbar 131, and a busbar frame 132 that supports the terminal busbar 131 and is mounted and demounted on/from the front open end portion O or the rear open end portion of the cell cover 120 by snap-fit.

The terminal busbar 131 may be made of, for example, metal such as copper, nickel and aluminum, and the busbar frame 132 may be made of, for example, an electrically insulating material such as plastics.

The busbar frame 132 may be approximately in the shape of a plate of a sufficient size to cover the front open end portion O or the rear open end portion of the cell cover 120, and have a lead slit 132a to allow the electrode lead 111a of the pouch-type battery cell 111 to pass through. The electrode lead 111a of the pouch-type battery cell 111 may be connected to the terminal busbar 131 through the lead slit 132a. In this instance, a welding process may be performed to fix the electrode lead 111a to the terminal busbar 131.

For example, in FIG. 2, the positive electrode leads of two pouch-type battery cells 111 may be connected to the terminal busbar 131 at the front open end portion O of the cell cover 120, and the negative electrode leads may be connected to the terminal busbar 131 at the rear open end portion of the cell cover 120. In this case, the terminal busbar 131 connected to the positive electrode leads may act as a positive terminal of the cell assembly 100, and the terminal busbar 131 connected to the negative electrode leads may act as a negative terminal of the cell assembly 100.

Meanwhile, the cell cover 120 according to the present disclosure is configured to adjust the width of the cell cover 120 according to the width of the cell stack 110.

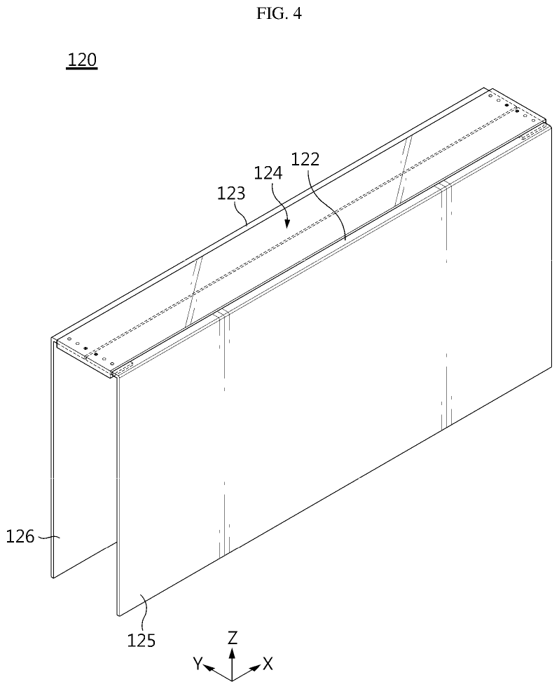

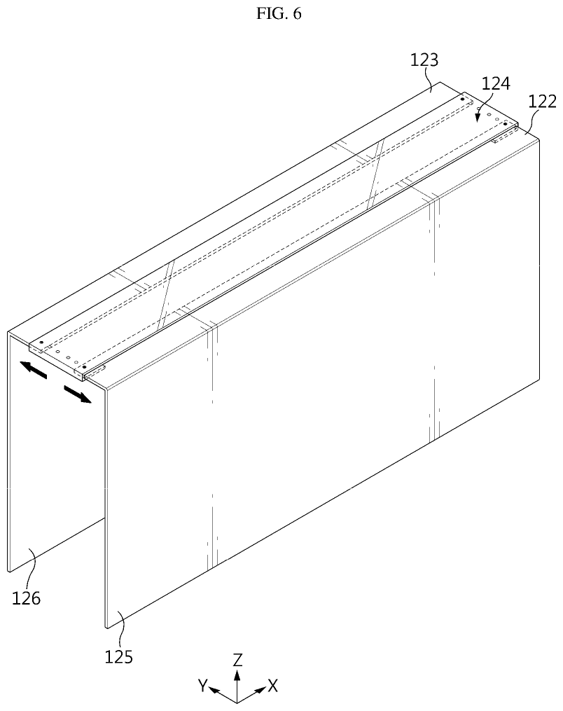

For example, as shown in FIG. 2, the cell cover 120 may include a width adjusting upper cover portion 121, a first side cover portion 125 and a second side cover portion 126, and like the exemplary configuration shown in FIGS. 4 and 6, the width of the cell cover may be adjusted by variably adjusting the width of the width adjusting upper cover portion 121. Hereinafter, the cell cover 120 will be described in more detail.

First, the first side cover portion 125 may extend in the downward direction from an edge line at one side along the widthwise direction (Y direction) of the width adjusting upper cover portion 121. The first side cover portion 125 may be longer than the receiving portion R of the pouch-type battery cell 111.

The first side cover portion 125 may be configured to cover one side portion of the cell stack 110. In particular, as shown in FIG. 1, the first side cover portion 125 may be configured to fully cover one side portion of the cell stack 110 in order to prevent the exposure of one side portion of the cell stack 110.

The second side cover portion 126 may extend in the downward direction from an edge line at the other side along the widthwise direction (Y direction) of the width adjusting upper cover portion 121. Preferably, the second side cover portion 126 and the first side cover portion 125 may be parallel and symmetrical to each other.

The second side cover portion 126 may be configured to cover the other side portion of the cell stack 110. In particular, the second side cover portion 126 may be configured to fully cover the other surface portion of the cell stack 110 in order to prevent the exposure of the other side portion of the cell stack 110.

The width adjusting upper cover portion 121 may be configured to cover the upper surface portion of the cell stack 110. In particular, as shown in FIG. 1, the width adjusting upper cover portion 121 may be configured to fully cover the upper surface portion of the cell stack 110 in order to prevent the exposure of the upper surface portion of the cell stack 110.

With the cell cover 120, for example, when the cell assembly 100 is disposed on the bottom surface of the pack case 200, it may be possible to stably keep the pouch-type battery cells 111 stacked and upright, and cool the pouch-type battery cells 111 by the indirect/direct contact between a cooling medium and the lower edge portions of the pouch-type battery cells 111.

In particular, as shown in FIG. 3, the width adjusting upper cover portion 121 includes a first upper cover portion 122 integrally formed with the first side cover portion 125, and a second upper cover portion 123 separated from the first upper cover portion 122 and integrally formed with the second side cover portion 126. Additionally, the width adjusting upper cover portion 121 may include a joint bracket unit 124 connected to the first upper cover portion 122 and the second upper cover portion 123, and configured to support the first upper cover portion 122 and the second upper cover portion 123 horizontally movably at the same height.

The first upper cover portion 122 may be in the shape of a plate that is bent from the upper end of the first side cover portion 125. Additionally, the first upper cover portion 122 may have a width that is shorter than the width of the joint bracket unit 124.

The second upper cover portion 123 may be in the shape of a plate that is bent from the upper end of the second side cover portion 126 and have a width that is shorter than the width of the joint bracket unit 124. The first upper cover portion 122 and the second upper cover portion 123 may be configured such that at least a portion of each of the first upper cover portion 122 and the second upper cover portion 123 is inserted into the joint bracket unit 124 as described below. Preferably, the first upper cover portion 122 and the second upper cover portion 123 may be symmetrical to each other.

That is, the first upper cover portion 122 and the first side cover portion 125 may be formed as a part, and the second upper cover portion 123 and the second side cover portion 126 may be formed as another part. The two parts may be linked by the joint bracket unit 124 as described below.

As shown in FIG. 3, the joint bracket unit 124 according to this embodiment may include a cover plate portion 124a and a link portion 124b.

The cover plate portion 124a may be in the shape of a plate having a length corresponding to a length of the cell cover 120. Additionally, the cover plate portion 124a may have a width that is at least equal to or smaller than the sum of the width of the first upper cover portion 122 and the width of the second upper cover portion 123.

The cover plate portion 124a may act as a shield to prevent the exposure of the upper surface portion of the cell stack 110 between the first upper cover portion 122 and the second upper cover portion 123 when the first upper cover portion 122 and the second upper cover portion 123 as described below are placed with a gap therebetween.

The link portion 124b is the component for connecting the joint bracket unit 124 to the first upper cover portion 122 or the joint bracket unit 124 to the second upper cover portion 123. The link portion 124b may be disposed in at least one end portion of the cover plate portion 124a along the lengthwise direction (X direction) of the cover plate portion 124a, and have a bent shape to cover the end portion of the first upper cover portion 122 and the end portion of the second upper cover portion 123 in the inward direction.

More specifically, as shown in FIG. 3, the link portion 124b may include a bent portion 124c bent in the downward direction from the end portion of the cover plate portion 124a, and a support portion 124d extending in a direction perpendicular to the bent portion 124c and configured to support the first upper cover portion 122 and the second upper cover portion 123 together below the first upper cover portion 122 and the second upper cover portion 123.

The support portion 124d may be spaced a predetermined distance apart from the cover plate portion 124a and have a plate surface parallel to the cover plate portion 124a. The distance between the support portion 124d and the cover plate portion 124a may correspond to the thickness of the first upper cover portion 122 and the second upper cover portion 123.

With the link portion 124b, as shown in FIGS. 3 to 5, the first upper cover portion 122 may be inserted into the space between the cover plate portion 124a and the link portion 124b. In particular, as shown in FIG. 4, the two end portions of the first upper cover portion 122 may be supported by two link portions 124b. In this case, the first upper cover portion 122 may be connected to the joint bracket unit 124 so that the first upper cover portion 122 is not allowed to move in the front-rear direction (±X direction) and the up-down direction (±Z direction) and only allowed to move in the left-right direction (±Y direction).

The two end portions of the second upper cover portion 123 may be inserted into the space between the cover plate portion 124a and the link portion 124b in a direction facing the two end portions of the first upper cover portion 122. As shown in FIG. 4, the two end portions of the second upper cover portion 123 may be also supported by the two link portions 124b, and the second upper cover portion 123 may be connected to the joint bracket unit 124 so that the second upper cover portion 123 is not allowed to move in the front-rear direction (±X direction) and the up-down direction (±Z direction), and only allowed to move in the left-right direction (±Y direction).

With the cell cover 120, the horizontal width of the cell cover 120 may be adjusted by relatively moving the first upper cover portion 122 or the second upper cover portion 123 in the left-right direction with respect to the joint bracket unit 124. For example, as shown in FIG. 4, in a state that the first upper cover portion 122 and the second upper cover portion 123 are coupled to the joint bracket unit 124, as shown in FIG. 6, each of the first upper cover portion 122 and the second upper cover portion 123 is partially pulled from the joint bracket unit 124. Accordingly, as the gap between the first side cover portion 125 and the second side cover portion 126 increases, the internal space of the cell cover 120 may be expanded.

Additionally, the cell cover 120 according to this embodiment may be configured such that the gap between the first upper cover portion 122 and the second upper cover portion 123 may be adjusted and the adjusted gap may be maintained.

To this end, the joint bracket unit 124 may include at least one first fastening hole H1˜H6 at a preset location, and the first upper cover portion 122 and the second upper cover portion 123 may include at least one second fastening hole K1,K4 that vertically match the first fastening holes H1˜H6 by the relative movement with respect to the joint bracket unit 124. Additionally, a fastener may be inserted into the first fastening holes H1˜H6 and the second fastening holes K1,K4 that vertically match each other. At least one of the first fastening holes H1˜H6 or the second fastening holes K1,K4 may have screw threads, and the fastener may be a bolt B1 that may be fastened to the screw threads.

For example, as shown in FIGS. 3 and 4, the first fastening holes H1˜H6 and the second fastening holes K1,K4 may be disposed at two end portions of the width adjusting upper cover portion 121. Here, six first fastening holes H1˜H6 may be disposed at each of one end portion and the other portion of the joint bracket unit 124, and one second fastening hole K1,K4 may be disposed at each of one end portion and the other portion of the first upper cover portion 122 and each of one end portion and the other portion of the second upper cover portion 123.

Additionally, the six first fastening holes H1˜H6 may be disposed at an overlapping area of the cover plate portion 124a and the support portion 124d in the joint bracket unit 124, and be spaced apart from each other along the widthwise direction of the joint bracket unit 124. Additionally, the second fastening hole K1 of the first upper cover portion 122 and the second fastening hole K4 of the second upper cover portion 123 may be located on the same line as the six first fastening holes H1˜H6.

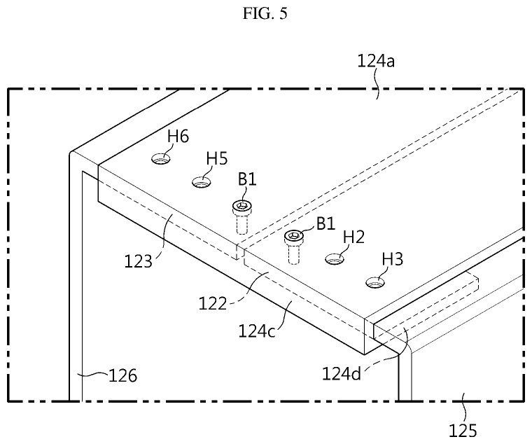

Accordingly, when each of the two end portions of the first upper cover portion 122 and the two end portions of the second upper cover portion 123 is pushed into the space between the cover plate portion 124a and the support portion 124d of the joint bracket unit 124, one of the first fastening holes H1˜H6 may vertically match the second fastening hole K1 or the second fastening hole K4 of the first upper cover portion. In this case, for example, as shown in FIG. 5, the first upper cover portion 122 and the joint bracket unit 124 may be fixed and coupled by installing the bolt in the second fastening hole K1 of the first upper cover portion 122 and the first fastening hole H1 among the first fastening holes H1˜H6 of the joint bracket unit 124 that matches it. Likewise, the second upper cover portion 123 and the joint bracket unit 124 may be fixed and coupled by installing the bolt B1 in the second fastening hole K4 of the second upper cover portion 123 and the first fastening hole H4 among the first fastening holes H1˜H6 of the joint bracket unit 124 that matches it.

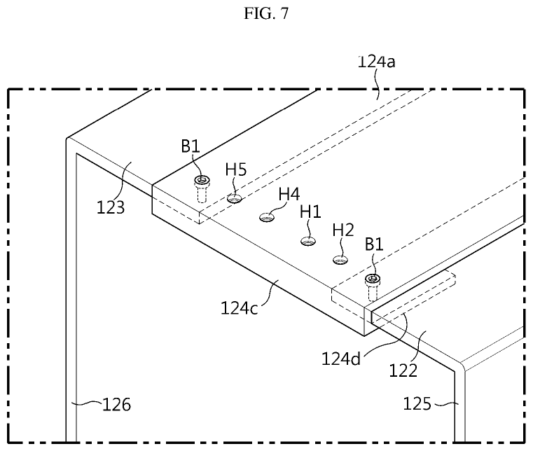

Meanwhile, when extending the width of the cell cover 120, after loosening the bolt B1 from the cell cover 120 of FIG. 5, at least one of the first upper cover portion 122 or the second upper cover portion 123 is partially pulled from the joint bracket unit 124. Additionally, for example, as shown in FIG. 7, the first upper cover portion 122 and the joint bracket unit 124 may be fixed and coupled by installing the bolt B1 in the second fastening hole K1 of the first upper cover portion 122 and the first fastening hole H3 among the first fastening holes H1˜H6 of the joint bracket unit 124 that matches it. Likewise, the second upper cover portion 123 and the joint bracket unit 124 may be fixed and coupled by installing the bolt in the second fastening hole K4 of the second upper cover portion 123 and the first fastening hole H6 among the first fastening holes H1˜H6 of the joint bracket unit 124 that matches it.

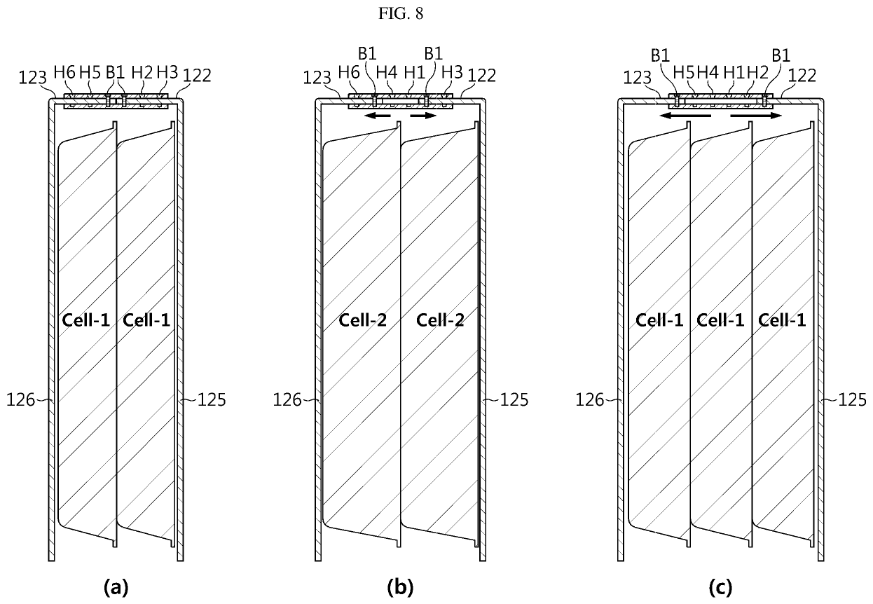

Accordingly, since the width of the cell cover 120 according to an embodiment of the present disclosure as described above can be adjusted, for example, as shown in FIGS. 8 (a), 8 (b) and 8 (c), it may be possible to receive the pouch-type battery cells 111 having different thicknesses as indicated by “Cell_1” and “Cell_2” or additional pouch-type battery cell(s) 111 using the same cell cover 120.

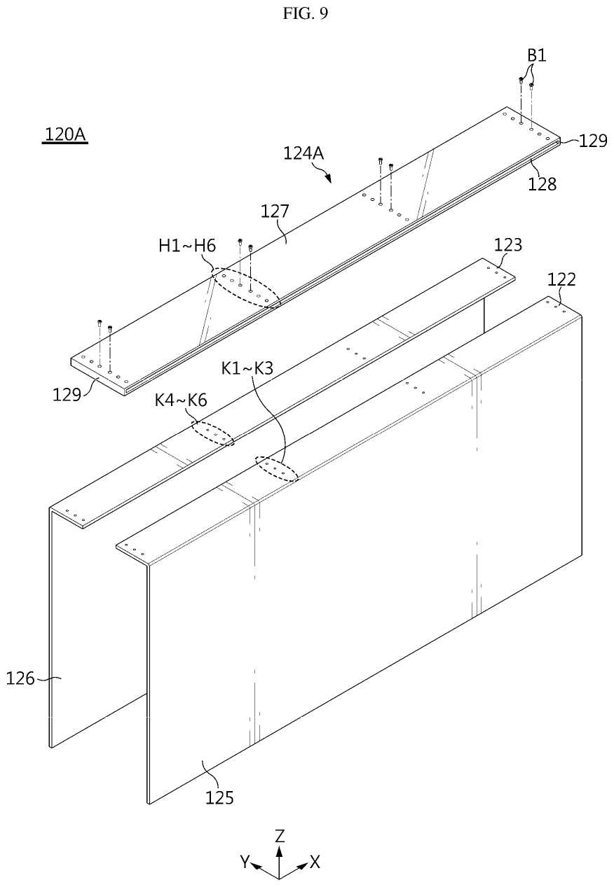

Subsequently, the cell assemblies according to other embodiments of the present disclosure will be described with reference to FIGS. 9 to 12.

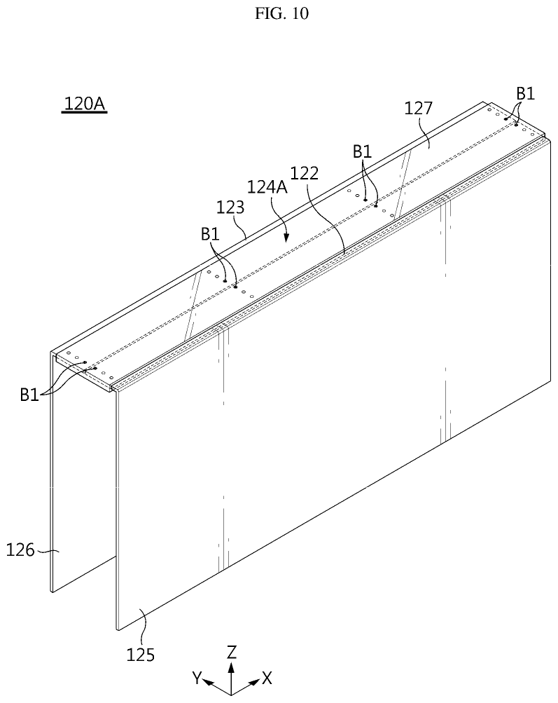

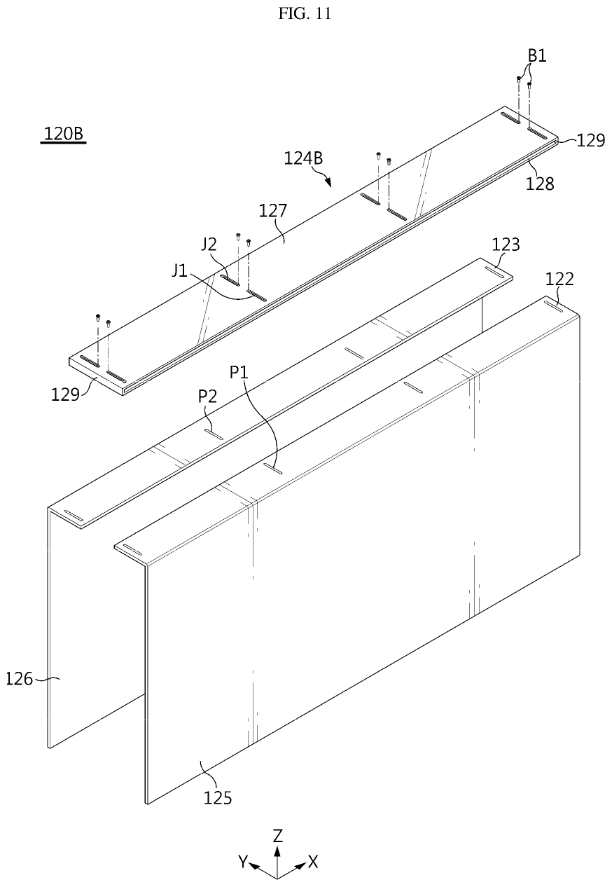

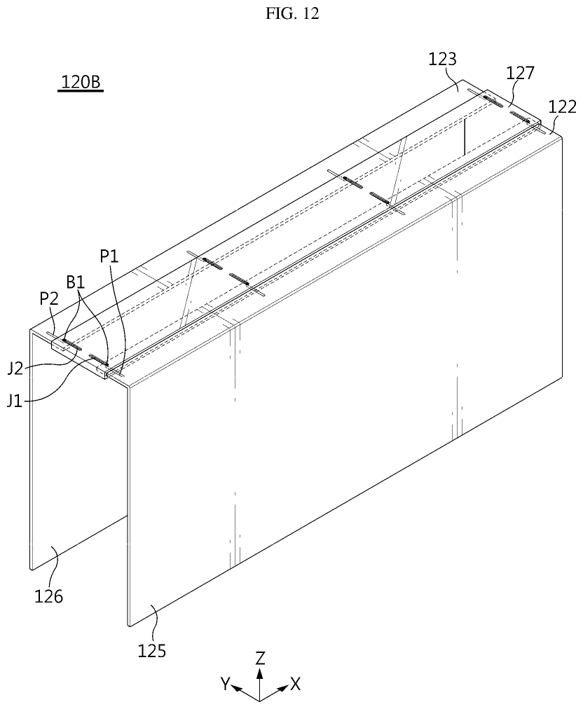

FIG. 9 is a perspective view showing the main components of the cell cover 120A according to a second embodiment of the present disclosure, FIG. 10 is an assembled perspective view of the cell cover 120A of FIG. 9, FIG. 11 is a perspective view showing the main components of the cell cover 120B according to a third embodiment of the present disclosure, and FIG. 12 is an assembled perspective view of the cell cover 120B of FIG. 11.

The same element as the previous embodiment is given the same reference sign, and a redundant description of the same element is omitted and difference(s) between this embodiment and the previous embodiment will be described.

When compared with the previous embodiment, the other embodiments of the present disclosure is mainly different in the joint bracket unit 124 of the cell cover and the other components are substantially the same. Accordingly, the following description will be made based on the joint bracket unit 124.

As opposed to the joint bracket unit 124 of the previous embodiment, the joint bracket unit 124A of the cell assembly according to the second embodiment of the present disclosure may cover and support not only the two end portions of first and second upper cover portions 122,123 but also parts between the two end portions of the first and second upper cover portions 122,123.

As shown in FIGS. 9 and 10, the joint bracket unit 124A according to the second embodiment may include a first cover plate portion 127 disposed on the first upper cover portion 122 and the second upper cover portion 123, a second cover plate portion 128 disposed below the first upper cover portion 122 and the second upper cover portion 123, and a connection portion 129 covering the end portion of the first upper cover portion 122 and the end portion of the second upper cover portion 123 together and connecting the first cover plate portion 127 to the second cover plate portion 128.

The distance between the first cover plate portion 127 and the second cover plate portion 128 may correspond to the thickness of the first upper cover portion 122 and the second upper cover portion 123. Additionally, the joint bracket unit 124 may be configured to push the first upper cover portion 122 and the second upper cover portion 123 into the space between the first cover plate portion 127 and the second cover plate portion 128.

The joint bracket unit 124A according to the second embodiment of the present disclosure may have higher durability and support the first and second upper cover portions 122,123 more stably than the joint bracket unit 124 of the previous embodiment. Accordingly, in particular, it may be effective when applied to the cell cover 120A that will accommodate the long pouch-type battery cells 111.

Additionally, as shown in FIG. 9, the joint bracket unit 124A according to the second embodiment may have, for example, six first fastening holes H1˜H6 arranged at a predetermined interval along the lengthwise direction (X direction) of the joint bracket unit 124A. That is, the first fastening holes H1˜H6 may be disposed in not only the two end portions of the joint bracket unit 124A but also the area between them.

Additionally, the second fastening holes K1˜K3 of the first upper cover portion 122 and the second fastening holes K4˜K6 of the second upper cover portion 123 may be located on the same line as the six first fastening holes H1˜H6. In this instance, as shown in FIG. 9, the first upper cover portion 122 may have three second fastening holes K1˜K3 arranged at a predetermined interval, and the second upper cover portion 123 may have three second fastening holes K4˜K6 arranged at a predetermined interval.

Accordingly, as shown in FIG. 10, the first upper cover portion 122 and the joint bracket unit 124 may be fixed and coupled by installing the bolt B1 in the second fastening hole K1˜K3 of the first upper cover portion 122 and the first fastening hole H1 among the first fastening holes H1˜H6 of the joint bracket unit 124 that matches it. Likewise, the second upper cover portion 123 and the joint bracket unit 124 may be fixed and coupled by installing the bolt B1 in the second fastening hole K4˜K6 of the second upper cover portion 123 and the first fastening hole H4 among the first fastening holes H1˜H6 of the joint bracket unit 124 that matches it.

As described above, when extending the width of the cell cover 120, after loosening the bolt B1, at least one of the first upper cover portion 122 or the second upper cover portion 123 is partially pulled from the joint bracket unit 124 and the bolt B1 is installed again in the first fastening holes H1˜H6 and the second fastening holes K1˜K6 that vertically match.

Meanwhile, as shown in FIG. 11, the joint bracket unit 124B of the cell assembly according to the third embodiment of the present disclosure and the joint bracket unit 124A of the second embodiment are different in the shape of the fastening hole. That is, the first cover plate portion 127 of the joint bracket unit 124B according to the third embodiment may have first long holes J1,J2 at a preset location, and the first upper cover portion 122 and the second upper cover portion 123 may have second long holes P1,P2, respectively. By the horizontal movement of the first upper cover portion 122 or the second upper cover portion 123, the first long holes J1,J2 and the second long holes P1,P2 may match each other at least in part. For example, as shown in FIG. 12, the joint bracket unit 124B and the first and second upper cover portions 122,123 may be fixed and coupled by installing the bolt at a location at which the first long holes J1,J2 of the joint bracket unit 124B and the second long holes P1,P2 of the first and second upper cover portions 122,123 vertically match each other.

In the case of the first or second embodiment, it is necessary to accurately match the first fastening holes H1˜H6 and the second fastening holes K1˜K6 to bolt-connect the joint bracket unit 124 to the first upper cover portion 122 or the joint bracket unit 124 to the second upper cover portion 123, so it is difficult to finely adjust the width of the cell cover 120. However, in the case of the third embodiment, in a range in which the first long holes J1,J2 and the second long holes P1,P2 match or align each other, the joint bracket unit 124B and the first upper cover portion 122 or the joint bracket unit 124B and the second upper cover portion 123 may be fixed with the bolt B1. Accordingly, according to the third embodiment, it may be possible to adjust the width of the cell cover 120B more finely than the previous embodiment.

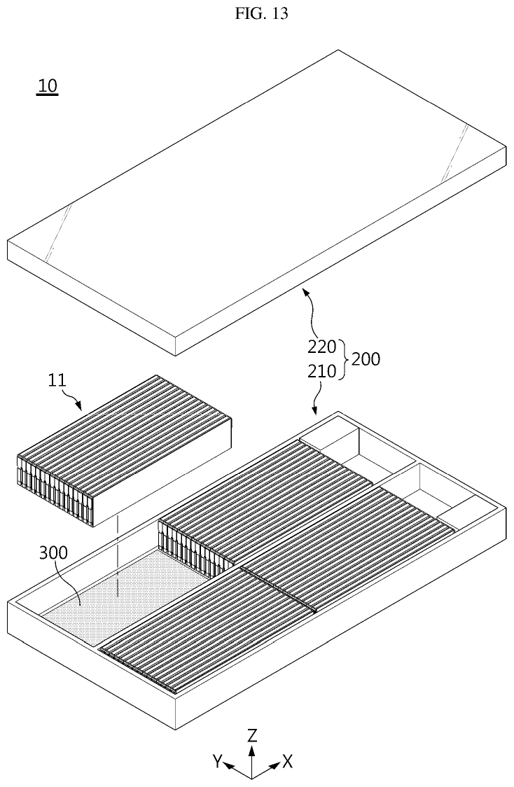

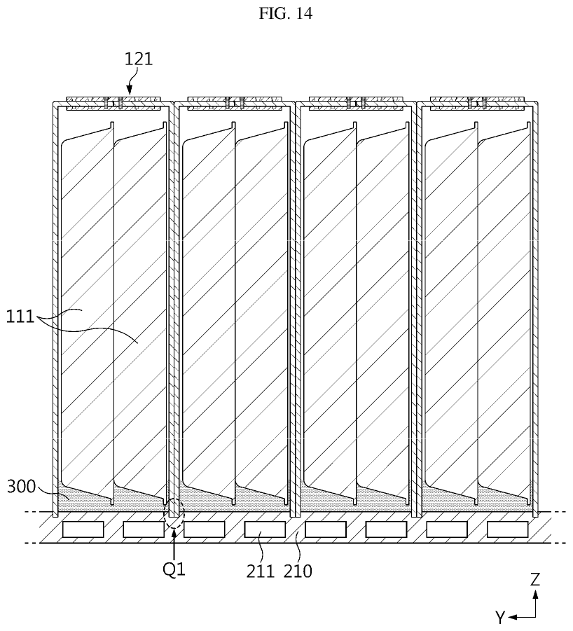

FIG. 13 is a schematic diagram of the battery pack 10 according to an embodiment of the present disclosure, and FIG. 14 is a partial cross-sectional view of the battery pack 10 according to an embodiment of the present disclosure.

Referring to FIGS. 13 and 14, the battery pack 10 according to an embodiment of the present disclosure may include a cell assembly group 11 including the cell assemblies 100 stacked in a direction and the pack case 200 accommodating at least one cell assembly group 11.

As shown in FIG. 13, the cell assembly group 11 may include a predetermined number of cell assemblies 100 stacked with the first side cover portion 125 or the second side cover portion 126 facing each other. Additionally, although not shown in the drawings for convenience, the cell assemblies 100 may be connected in series or in parallel.

As shown in FIG. 13, the pack case 200 includes a pack tray 210 and a pack cover 220. The pack tray 210 may be in the shape of a box with an open top, so the plurality of cell assembly groups 11 may be received in the internal space. Additionally, the pack cover 220 may be in the shape of a cover that covers the open top of the pack tray 210. In this instance, the pack cover 220 may be in the shape of a box with an open bottom. The pack case 200 may be made of plastics or metals. The material of the pack case 200 may include various types of packaging materials of the battery pack 10 known at the time of filing the application.

In particular, as shown in FIG. 13, a bottom plate of the pack tray 210 on which the cell assembly group 11 is mounted may have a thermally conductive adhesive 300. Accordingly, the cell assembly group 11 may be adhered and fixed to the pack tray 210.

Additionally, as shown in FIG. 14, the pack tray 210 may include a cooling channel 211 in which a cooling medium flows. That is, the pack tray 210 itself may act as a heatsink due to the cooling channel 211 in the bottom plate. Here, the heatsink refers to an object that absorbs heat and carries it away from another object through direct/indirect thermal contact.

In particular, according to the present disclosure, as described above, the cell cover 120 may be configured such that the lower edge portion E2 of the pouch-type battery cell 111 is exposed. Accordingly, when the cell assembly group 11 is mounted on the bottom plate of the pack tray 210, the lower edge portion E2 of the pouch-type battery cell 111 may directly contact the bottom plate of the pack tray 210. In this instance, the thermally conductive adhesive 300 filled between the lower edge portion E2 of the pouch-type battery cell 111 and the bottom plate of the pack tray 210 may improve fixation of the pouch-type battery cells 111 and heat dissipation performance. Accordingly, it may be possible to transfer heat from all the pouch-type battery cells 111 mounted in the battery pack 10 to the pack case 200 more effectively, thereby enhancing cooling performance of the battery pack 10. Additionally, the battery pack 10 according to the present disclosure does not need a cooling structure between the pouch-type battery cell 111 and the pack case 200, thereby achieving efficient cooling performance.

Additionally, the pack tray 210 may have a fixing groove to which the lower end of the cell cover 120 is inserted and fixed. That is, the lower end of the first side cover portion 125 and the lower end of the second side cover portion 126 of the cell cover 120 may be inserted into the bottom plate of the pack tray 210. For example, as indicated by ‘Q1’ in FIG. 14, a portion of the lower end of each cell cover 120 may be inserted and fixed to the bottom plate of the pack tray 210. Accordingly, the cell covers 120 may stand upright in the pack tray 210 more stably.

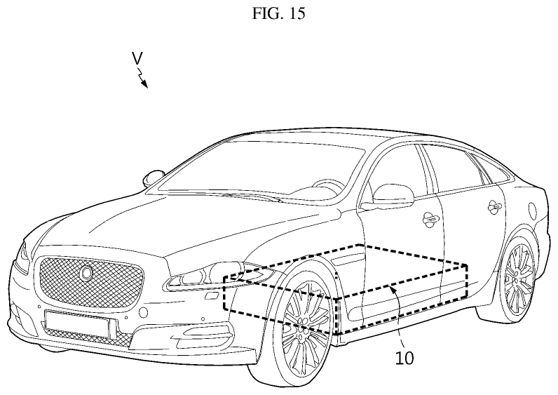

Meanwhile, the battery pack 10 according to the present disclosure may be used as an energy source for driving a vehicle. That is, the vehicle V according to the present disclosure may include the battery pack 10 according to the present disclosure as shown in FIG. 15. Here, the vehicle according to the present disclosure may include, for example, a predetermined vehicle that is powered by electricity such as an electric vehicle or a hybrid electric vehicle. Additionally, in addition to the battery pack 10 according to the present disclosure, the vehicle according to the present disclosure may further include a variety of other components included in the vehicle, for example, a vehicle body or a motor.

The terms indicating directions such as upper, lower, left, right, front and rear are used for convenience of description, but it is obvious to those skilled in the art that the terms may change depending on the position of the stated element or an observer.

While the present disclosure has been hereinabove described with regard to a limited number of embodiments and drawings, the present disclosure is not limited thereto and it is apparent that a variety of changes and modifications may be made by those skilled in the art within the technical aspect of the present disclosure and the scope of the appended claims and their equivalents.

1. A cell assembly, comprising:
a cell stack including one or more pouch-type battery cells or two or more pouch type battery cells stacked; and
a cell cover covering two side portions of the cell stack along a widthwise direction of the cell stack and a top portion of the cell stack,
wherein a width of the cell cover is adjustable according to a width of the cell stack.

2. The cell assembly according to claim 1, wherein the cell cover is configured to cover the cell stack such that a bottom portion of the cell stack is exposed.

3. The cell assembly according to claim 1, wherein the cell cover includes:
a width adjusting upper cover portion covering an upper surface portion of the cell stack, and having a variably adjustable width;
a first side cover portion extending in a downward direction from an edge at one side of the width adjusting upper cover portion and covering one side portion of the cell stack; and
a second side cover portion extending in the downward direction from an edge at the other side of the width adjusting upper cover portion and covering the other side portion of the cell stack.

4. The cell assembly according to claim 3, wherein the width adjusting upper cover portion includes:
a first upper cover portion integrally formed with the first side cover portion;
a second upper cover portion separated from the first upper cover portion, and integrally formed with the second side cover portion; and
a joint bracket unit connected to the first upper cover portion and the second upper cover portion, and configured to support the first upper cover portion and the second upper cover portion horizontally movably at a same height.

5. The cell assembly according to claim 4, wherein the joint bracket unit includes:
a cover plate portion disposed on the first upper cover portion and the second upper cover portion; and
a link portion disposed in at least one end portion of the cover plate portion along a lengthwise direction of the cover plate portion, and having a bent shape to cover an end portion of the first upper cover portion and an end portion of the second upper cover portion in an inward direction.

6. The cell assembly according to claim 5, wherein the link portion includes:
a bent portion bent in the downward direction from an end portion of the cover plate portion; and
a support portion extending in a direction perpendicular to the bent portion, and configured to support the first upper cover portion and the second upper cover portion together below the first upper cover portion and the second upper cover portion.

7. The cell assembly according to claim 4, wherein the joint bracket unit has a first fastening hole at a preset location, and
wherein the first upper cover portion and the second upper cover portion include at least one second fastening hole that vertically matches the first fastening hole by a relative movement with respect to the joint bracket unit.

8. The cell assembly according to claim 4, wherein the joint bracket unit includes:
a first cover plate portion disposed on the first upper cover portion and the second upper cover portion;
a second cover plate portion disposed below the first upper cover portion and the second upper cover portion; and
a connection portion covering an end portion of the first upper cover portion and an end portion of the second upper cover portion together and connecting the first cover plate portion to the second cover plate portion.

9. The cell assembly according to claim 8, wherein the first cover plate portion has a first long hole at a preset location,
each of the first upper cover portion and the second upper cover portion has a second long hole, and
the first long hole and the second long hole match each other at least in part by horizontal movement of the first upper cover portion or the second upper cover portion.

10. The cell assembly according to claim 1, further comprising:
a busbar assembly having a terminal busbar electrically connected to an electrode lead of the pouch-type battery cell.

11. A battery pack, comprising:
a cell assembly group including the cell assemblies according to claim 1 stacked in a direction; and
a pack case including a pack tray on which the cell assembly group is mounted, and a pack cover covering the cell assembly group.

12. The battery pack according to claim 11, wherein the cell assembly group is adhered and fixed to an upper surface of the pack tray.

13. The battery pack according to claim 11, wherein the pack tray includes a cooling channel in which a cooling medium flows.

14. The battery pack according to claim 11, wherein the pack tray has a fixing groove to which a lower end of the cell cover is inserted and fixed.

15. A vehicle comprising the battery pack according to claim 11.
